(19) United States
(12) Patent Application Publication
(10) Pub. No.: US 2016/0047953 A1
(43) Pub. Date: Feb. 18, 2016

(54) DOUBLE-SIDED REFLECTIVE WEBBING FOR PEDESTRIAN TRAFFIC CONTROL DEVICES

(71) Applicant: Peter James Crawley, Buckinghamshire (GB)

(72) Inventor: Peter James Crawley, Buckinghamshire (GB)

(21) Appl. No.: 14/827,793

(22) Filed: Aug. 17, 2015

Related U.S. Application Data
(60) Provisional application No. 62/070,225, filed on Aug. 18, 2014.

(51) Int. Cl. G02B 5/136; E01F 9/011; E01F 13/02

(52) U.S. Cl. CPC G02B 5/136; E01F 13/022; E01F 13/028; E01F 9/0111

(57) ABSTRACT

Webbing for a pedestrian traffic control device is spooled in a cartridge, which can be mounted on a stanchion, cone mount or wall mount or other device. The webbing can be extended to another stanchion, cone mount, wall mount or other device in order to create a barrier. The webbing is reflective on two sides in order to provide more visibility and more safety.

### CROSS-REFERENCE TO RELATED APPLICATIONS

This application claims priority from Provisional Application No. 62/070,225, filed Aug. 18, 2014, incorporated by reference.

### BACKGROUND

Pedestrian traffic control devices are used to direct the flow of pedestrians at locations such as airports, movie theaters, construction zones or anywhere there may be queues or routes for pedestrians to follow. A common design is a device with two or more stanchions, poles or barriers connected by tape, ribbon or webbing. The stanchions are connected such that they form a path for the pedestrians to follow to their destination at the end of the queue. These devices may also be used to simply cordon off an area to prevent people from entering the area or to warn them of danger. An example is the Tensabarrier® system, an example of which can be found at http://www.tensabarrierdirect.com/us/#tensabarrier. FIG. 1 shows the Tensabarrier® system with webbing 10 housed in, and extending from, cartridge 20, which may be mounted on stanchion 30. The other end of webbing 10 can be attached to receiver 21, which is mounted on another stanchion 30′, forming a barrier.

It may be advantageous for the webbing to be reflective, such that the queue is visible to vehicles traveling near the queue. This offers safety from the vehicles and other traffic for the pedestrians in the queue. Webbing having a reflective strip on one side is limited in use, as the vehicles may be coming from multiple directions. Vehicles on the opposite side of the reflective strip would not see the queue if the webbing is reflective on only one side.

There is prior art webbing that is reflective over the full width of the webbing on a single side and has a non-reflective backing. However, it is not possible to simply place two strips of this prior art webbing back to back to make it reflective on both sides, because the combination would be too thick to work properly in the cartridges that hold the webbing without substantial modification to the cartridges and the mounts.

There is also prior art webbing with a reflective strip on both sides; however, the construction of this prior art webbing has many deficiencies. This prior art webbing is created from a reflective strip stitched lengthwise onto normal fabric, which can be easily damaged or removed. Due to this construction, it is not easy to print logos or other text or designs on the prior art webbing, and the prior art webbing is not easily cleaned, thus losing its reflectivity. The reflective strip of this prior art webbing does not cover the full width of the webbing, diminishing the reflectivity.

### SUMMARY OF THE INVENTION

It would be advantageous for the webbing to be reflective over the full width of both sides. This increases the safety of the pedestrians because vehicles approaching the reflected light of the webbing of the queue from multiple directions may more easily see the webbing and the queues even at night or during poor visibility conditions. The driver of a vehicle approaching from either side of the queue may be able to see both sides of the queue at the same time, enhancing visibility. In other uses, pedestrians would be able to more clearly see dangerous areas that are demarcated by the system.

A pedestrian traffic-control system is disclosed comprising webbing having length L and width W, said webbing comprising reflective material over the full width of both sides of the webbing, and wherein the first end of said webbing is connected to and housed in a cartridge; wherein the second end of the webbing is extendable from the cartridge and is attachable to a mount in order to form a pedestrian traffic control system.

The webbing is spooled and housed in a cartridge that can be mounted on a stanchion, a wall, a traffic cone, or other suitable device. Having multiple options for mounting the cartridge allows the system to be used in more locations and situations.

The webbing that is reflective on both sides can be formed from two pieces of single-sided reflective material that do not have a backing layer. Each piece is created with a prismatic layer that is integral to the construction of the webbing and may be covered by a clear layer. The two pieces may be heat-welded together with the prismatic layer of each piece facing outward.

One end of the webbing may be attached to a tape end by first creating a loop at the end of the webbing by heat-welding the end of the webbing to a portion of the webbing offset from the end and then inserting a pin or other fastener through the loop. The heat weld is strongest when formed by a plurality of welds, each extending in a direction parallel to the length L of the webbing. There may be a piece of material, such as PVC, placed between the two pieces of webbing that are welded together to act as an adhesive to strengthen the weld. The other end of the webbing is attached in a cartridge to a spindle, which is attached to a wound spring. The webbing can then be wound around the spindle and into the cartridge. Due to the material used for the webbing, the spring is wound tighter than for prior art webbing of the same length to ensure the webbing will retract properly.

### BRIEF DESCRIPTION OF THE DRAWINGS

FIG. 1 illustrates the known Tensabarrier® system.

FIG. 2 illustrates webbing according to an exemplary embodiment the invention.

FIGS. 3 illustrates an exemplary embodiment of the connections of the webbing within the system.

FIGS. 4A, 4B and 4C illustrate an exemplary embodiment of how the webbing is attached a spindle inside a cartridge.

FIGS. 5A and 5B illustrate a method of creating a loop to attach the webbing to a tape end.

FIG. 6 illustrates an exemplary embodiment of the invention mounted on a wall mount.

FIG. 7 illustrates an exemplary embodiment of the invention mounted on a traffic cone mount.

FIG. 8 illustrates an exemplary embodiment of the invention forming a corridor.

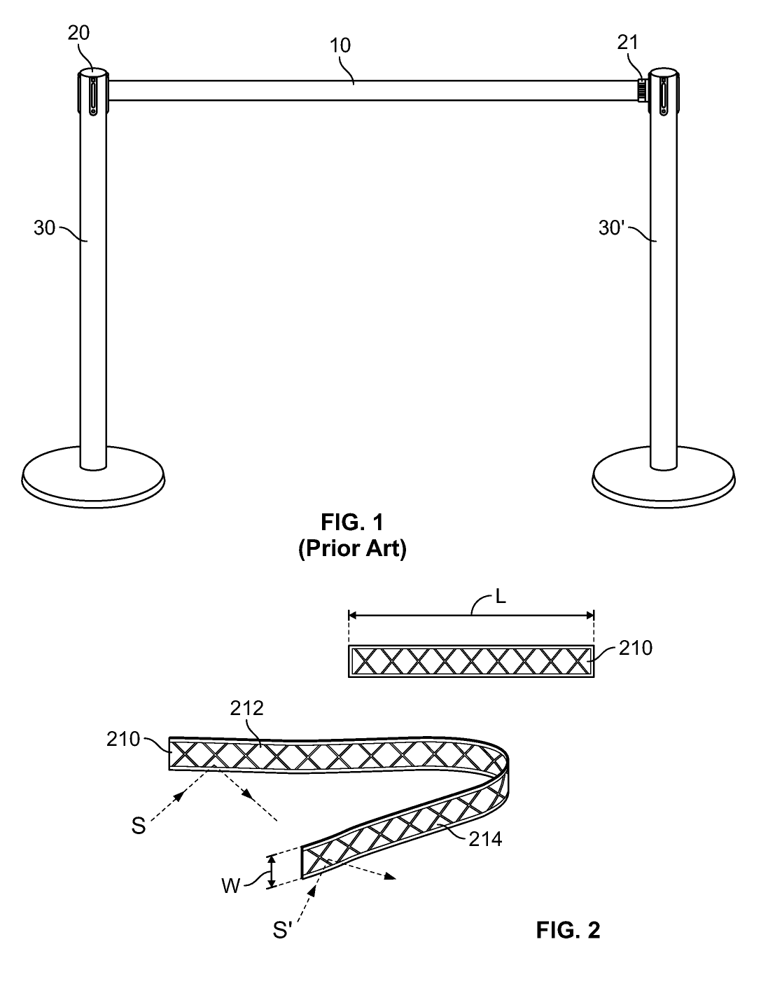

### DESCRIPTION OF THE EMBODIMENT

Disclosed is a pedestrian traffic control device, a method of making the device, and a system for controlling pedestrian traffic. The system may be a set including a mount, a cartridge and webbing. In particular, the webbing is reflective. The system may be used in dangerous places, such as construction zones, where it is essential that vehicles approaching the place from multiple directions can easily see the webbing. In this way, the headlights of approaching vehicles can reflect off of the webbing and shine back into the drivers' eyes, alerting the drivers to the presence of the danger or the pedestrians. Pedestrians approaching these dangerous places can also easily see the webbing, alerting them to the danger.

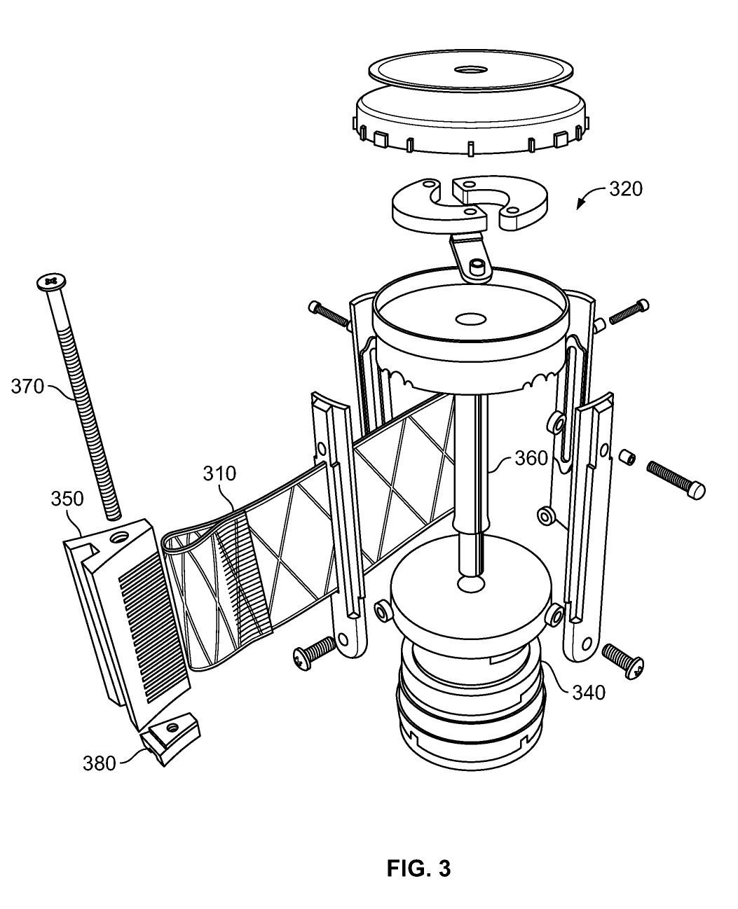

FIG. 2 shows an embodiment where webbing 210 is reflective on both the front side 212 and the back side 214. Light source S can be reflected off of the front 212 of webbing 210 and light source S′ can be reflected off of the back 214 of webbing 210. The webbing may comprise material that is reflective over the entire width W of both sides 212 and 214 of webbing 210. The entire length L of both sides 212 and 214 of webbing 210 may also be reflective. This full reflectivity of both the width and the length offers the advantage of extra reflectivity due to increased reflective surface area compared with webbing where only a portion is reflective.

By heat welding the ends of the webbing, critical weaknesses in the fabric that can be caused by stitching or other methods may be eliminated or mitigated. This can prevent the webbing from fraying or coming apart. The webbing may be comprised of two pieces of material, each reflective on a single side, heat welded together such that the reflective sides face away from each other, creating webbing that is reflective on both sides.

In an embodiment, each piece of material has a prismatic layer, which is reflective, that may be covered by a clear layer. The prismatic layer of one piece faces away from the prismatic layer of the other piece when the two pieces are attached, causing both sides of the combination to be reflective.

The webbing may be made from two pieces of PVC that are heat-welded together. The webbing may also be made from different materials, such as nylon, plastic, paper, textile, or a combination of the foregoing, so long as the described characteristics are maintained. The webbing may be also integrally formed as a single-piece.

FIG. 3 shows double-sided reflective webbing 310 housed in cartridge 320. One end of webbing 310 is connected to spindle 360, which is connected to spring 340. The other end of webbing 310 is attached to tape end 350, which is used to secure the webbing to a stanchion or other mount. When webbing 310 is extended from cartridge 320, spring 340 tightens, so that webbing 310 will automatically retract into cartridge 320 when not being secured to another mount.

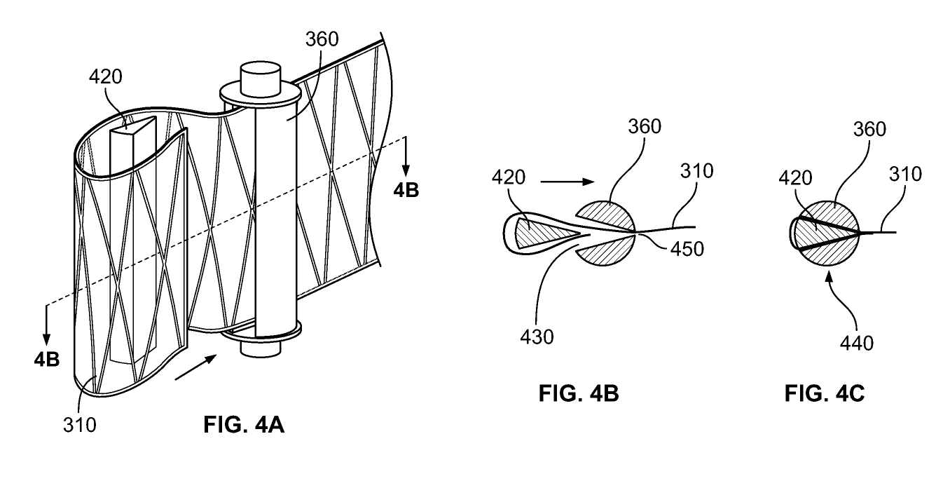

FIGS. 4A, 4B and 4C illustrate an exemplary embodiment of how webbing 310 may be connected to spindle 360 so that it does not come detached from spindle 360 when the webbing is extended from cartridge 320. FIG. 4B is a cross-sectional view of spindle 360 and webbing 310, as shown from 4B-4B in FIG. 4A. The end of webbing 310 is weaved through a slit 450 inside spindle 360 and then wrapped around wedge 420, which may be made from plastic or other suitable material. Wedge 420 is then pulled into V-shaped notch 430 in spindle 360 to be secured into place, as shown in FIG. 4C.

In an embodiment, before webbing 310 is connected to spindle 360, spring 340 is wound enough times to be able to fully wind webbing 310 around spindle 360 once webbing 310 is attached to spindle 360. Due to the characteristics of the disclosed embodiment of webbing 310, spring 340 must be wound more times than for traditional webbing in order for webbing 310 to fully wind around spindle 360. Due to the spring being wound more times than for traditional webbing, the extended webbing has more tension on it. Thus, the connection of the webbing to the tape end must be made stronger than in the prior art.

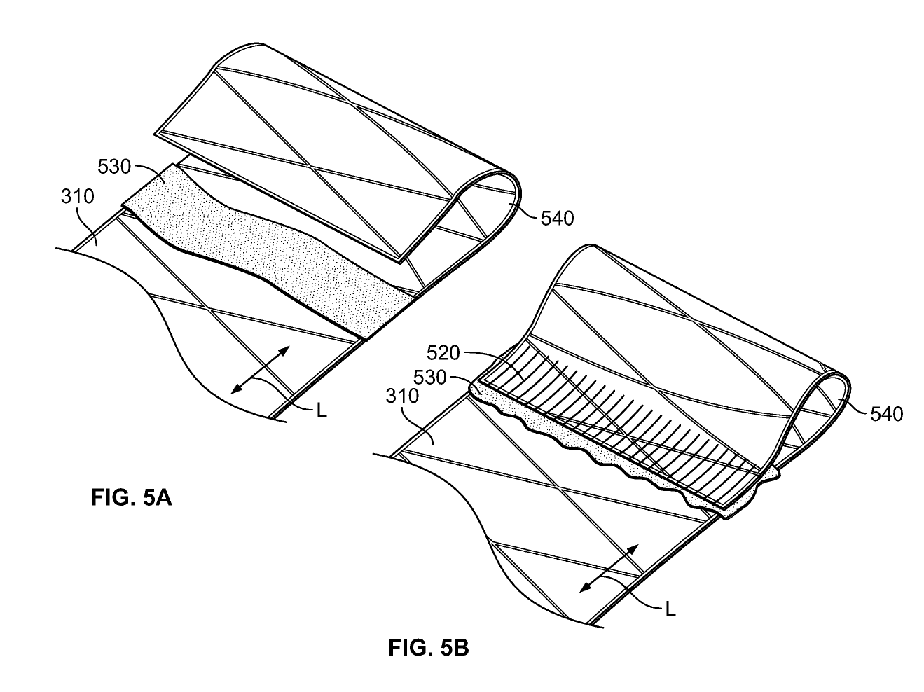

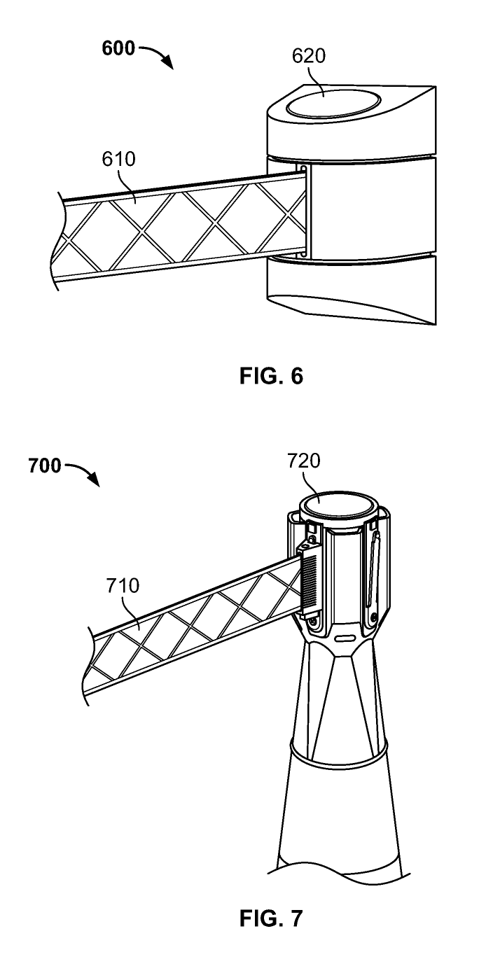

FIGS. 5A and 5B show a preferred method of creating the loop used to secure webbing 310 to tape end 350. Loop 540 is formed in the end of webbing 310 that is opposite to the end that is connected to spindle 360. Loop 540 is formed by heat welding this end of webbing 310 to a portion of the webbing that is slightly offset from this end of the webbing. Two exemplary options for creating strong a heat weld are described. A first option is to use a weld pattern 520 that is aligned in the same direction as the length L of webbing 310. This weld pattern is created by a plurality of individual heat welds, each of which extends in a direction parallel to the length L of webbing 310. This gives a stronger weld than a pattern at another angle, such as where each individual heat weld is 90° to length L of webbing 310. A second option is to add a layer of adhesive 530 between the two attached portions of the webbing. FIG. 5B shows the webbing with the adhesive layer after being heat welded. In the embodiment, adhesive 530 is made from PVC, but other suitable material may be used. Either of these options may be used alone, but in a preferred embodiment, both are implemented at the same time to ensure the webbing will not tear away from tape end 350 when the webbing is being extended from cartridge 320 or when extended and connected to another mount.

As shown in FIG. 3, after loop 540 is formed at the end of webbing 310, loop 540 is inserted into tape end 350 through a slot (not shown) in the tapered edge of tape end 305 and pin 370 is inserted through loop 540 and secured by attachment piece 380. Although a pin is shown here, other suitable mechanisms may be used to secure webbing 310 to tape end 350.

One option for tape end 350 is shown in FIG. 3, but other types of tape ends can be used that have different ways of being connected to a mount. One such example is where the tape end is magnetic and thus any metal surface can be used as a mount. Another example is where the tape end is made to break away from a mount under stress. In another example, tape end can be a wire clip, where loop 540 is slipped over the wire instead of being connected to the tape end via a pin.

In an embodiment, each side of the webbing may be a different color. This may aid an approaching vehicle to differentiate the sides of the queue. It may be advantageous for text, logos or other designs to be able to be printed on both sides of the webbing. The unique construction of the webbing allows for these designs to be printed on both sides of the webbing due to the reflective material not being stitched to the webbing, but rather being integral to the webbing. It may also be advantageous for the webbing to be non-absorbent, so that it can be wiped clean to preserve its reflectivity.

FIG. 6 shows an embodiment where webbing 610 is housed in and extends from cartridge 620, which is mounted to wall mount 600. Webbing 610 may be webbing 310, and cartridge 620 may be cartridge 320. Further examples of wall mounts are shown at http://www.tensabarrierdirect. com/us/categories/Wall-Mounted-Barriers/.

FIG. 7 shows an embodiment where webbing 710 is housed in and extends from cartridge 720, which is mounted on traffic cone mount 700. Webbing 710 may be webbing 310, and cartridge 720 may be cartridge 320. Further examples of this and other mounts may be found at http://www.tensabarrierdirect.com/us/categories/Tensabarrier/Plastic-Posts/.

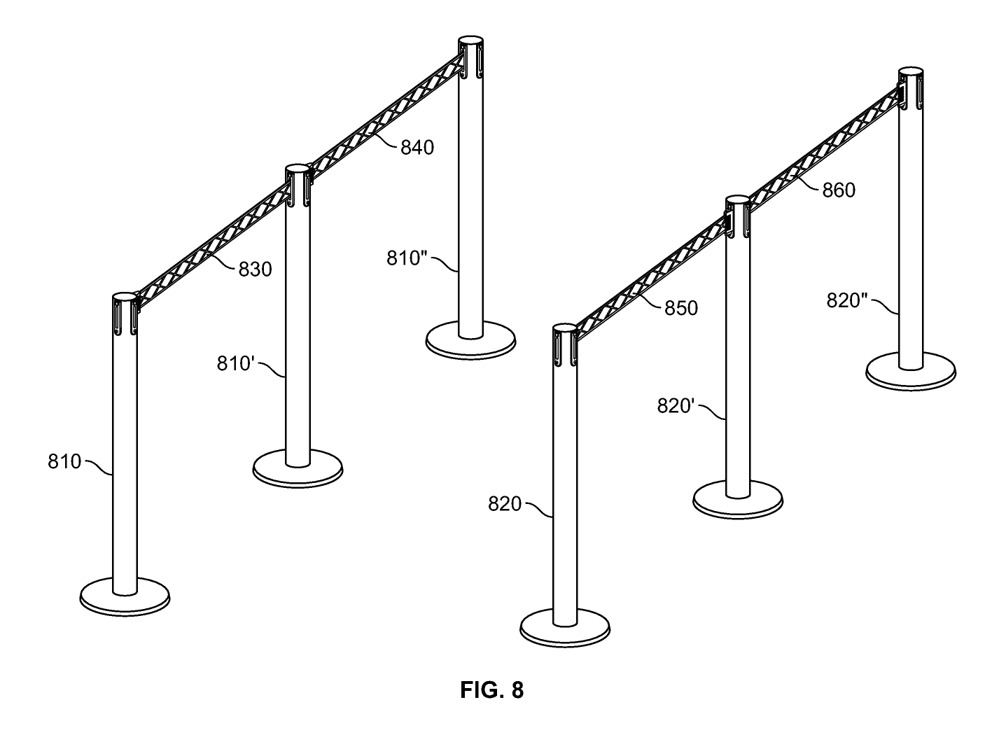

FIG. 8 shows an embodiment where two or more mounts are connected by webbing to form a corridor for pedestrians to follow. The pedestrians generally create a queue that flows within the corridor. In an embodiment, three stanchions 810, 810′ and 810″ are connected by webbing 830 and 840 on one side of the corridor and three stanchions 820, 820′ and 820″ are connected by webbing 850 and 860 on the other side of the corridor; however the lines of stanchions can be comprised of any number of stanchions, and each line can have a different number of stanchions. As can be seen in FIG. 8, all of the stanchions do not need to be connected, as there may be more than one side to the corridor. In an embodiment, webbing 830, 840, 850 and 860 may be of different construction or color. In an embodiment, a single line of stanchions that protects pedestrians and indicates where they should go may also be sufficient. In an alternate embodiment, some or all of the mounts may be traffic cone mounts, as shown in FIG. 7. In another embodiment, wall mounts may be used where appropriate.

The invention has been shown and described by way of example, and many variations may be made in the invention which will still be comprised within its spirit. It is understood, therefore, that the invention is not limited to any specific form or embodiment.

What is claimed is:

1. A pedestrian traffic-control system comprising:
webbing having length L and width W, said webbing comprising reflective material having a prismatic layer that is integral to the construction of the webbing and that spans the full width of each side of the webbing, wherein a first end of said webbing is connected to and housed in a cartridge;
wherein a second end of the webbing opposite to the first end is extendable from the cartridge and is attachable to a mount in order to form a pedestrian traffic control system.

2. The system of claim 1, wherein the second end of the webbing is connected to a tape end;
wherein second end of the webbing comprises a loop, the loop comprising the second end of the webbing connected to a portion of the webbing that is offset from the second end of the webbing.

3. The system of claim 2, wherein the second end of the webbing is heat welded to the portion of the webbing that is offset from the second end of the webbing.

4. The system of claim 3, wherein a plurality of individual heat welds each extends in a direction parallel with the length L of the webbing.

5. The system of claim 2, wherein a piece of adhesive is disposed between the second end of the webbing and the portion of the webbing to which the second end is connected.

6. The system of claim 5, wherein the second end of the webbing is heat welded to the adhesive and the portion of the webbing that is offset from the second end of the webbing.

7. The system of claim 6, wherein a plurality of individual heat welds each extends in a direction parallel with the length L of the webbing.

8. The system of claim 1, wherein said webbing is made from two pieces of material that are each reflective on a single side, said pieces of material heat-welded together with the reflective sides of each piece facing outward, away from the other piece of material.

9. The system of claim 7, wherein said material is PVC.

10. The system of claim 1, wherein each side of the webbing is a different color.

11. The system of claim 1, wherein said webbing is non-absorbent.

12. The system of claim 1, wherein the mount that holds the cartridge is a stanchion.

13. The system of claim 1, wherein the mount that holds the cartridge is a traffic-cone mount.

14. The system of claim 1, wherein the mount that holds the cartridge is a wall mount.

15. A method of making a pedestrian traffic-control system comprising:
connecting a first end of webbing having length L to a spindle, said webbing comprising reflective material having a prismatic layer that is integral to the construction of the webbing and that spans the full width of each side of the webbing;
connecting a second end of the webbing opposite to the first end to a tape end by creating a loop by heat welding the second end of the webbing to a portion of the webbing that is offset from the second end of the webbing, and inserting a pin through the loop;
wherein said spindle is housed in a cartridge.

16. The method of claim 15, wherein a piece of adhesive is disposed between the second end of the webbing and the portion of the webbing to which the second end is connected.

17. The method of claim 15, wherein said heat welding comprises a plurality of individual heat welds that each extend in a direction parallel with the length L of the webbing.

18. The method of claim 16, wherein said heat welding comprises a plurality of individual heat welds that each extend in a direction parallel with the length L of the webbing.

19. The method of claim 15, further comprising winding the webbing around said spindle, so that the webbing is housed within the cartridge.

20. The method of claim 18, further comprising mounting the cartridge onto a mount.
